(19) United States
(12) Patent Application Publication
(10) Pub. No.: US 2007/0272254 A1
(43) Pub. Date: Nov. 29, 2007

(54) Cushion for Positioning a Patient Having to Undergo a Lumbar Puncture

(76) Inventor: Serge Rochatte, Bagnols (FR)

Correspondence Address: CLARK & BRODY, 1090 VERMONT AVENUE, NW, SUITE 250, WASHINGTON, DC, 20005, US

(21) Appl. No.: 10/560,898

(22) PCT Filed: Jun. 17, 2004
(86) PCT No.: PCT/FR04/01501

§ 371 Date: Mar. 23, 2007

(30) Foreign Application Priority Data
Jun. 17, 2003 (FR) 03/07273

(51) Int. Cl. A61G 15/12

(52) U.S. Cl. 128/845

(57) ABSTRACT

A device for positioning a patient who is to undergo a lumbar puncture in particular a device having a plane of so-called sagittal symmetry, comprises a rigid or semi-rigid cushion that includes: a placing surface provided with an anterior edge and resting on the patient's thighs, a front leaning surface for the patient's abdomen and thorax, rising above the placing surface from the anterior edge and having a convex profile in the plane of sagittal symmetry to position the patient's spine in kyphosis, this front leaning surface, opposite the anterior edge, leading into a housing for supporting and laterally centring the patient's head, centred along the plane of sagittal symmetry, and two side faces in which a clasping surface opens oriented in opposite direction to the front leaning surface to allow at least part of the upper limbs to clasp the cushion against the patient's abdomen and thorax.

The present invention concerns the technical area of devices in their general meaning allowing patients to be placed in a determined position for a specific sampling procedure or for treatment for example.

The subject of the present invention finds particularly advantageous application in the area of lumbar punctures.

In this preferred area of lumbar punctures the patient must remain immobile throughout the entire procedure which requires great precision. Traditionally, the patient is seated with spinal flexure to adopt a posture of dorsal-lumbar kyphosis. To endeavour to help the patient remain immobile in this position, one stopgap solution is to use a pillow placed between the thighs and thorax. In practice this solution is not satisfactory on account of the lack of stability, the patient not being muscularly relaxed. As a result the puncture is a difficult procedure to conduct and may be painful for the patient.

In the state of the art a device is also known from patent FR 2 556 588 ensuring the positioning of a patient on an operating table. Said device comprises a seat, attached to the operating table, for immobilising the patient's pelvis and a cushion intended to give support to the patient's thorax. Aside from the fact that said device is difficult to use, this device does not make it possible to place the patient in a comfortable position to ensure relaxation of the muscles.

Also U.S. Pat. No. 6,154,903 describes a device for positioning a patient in prone position using a cushion in two parts. With this device it is not possible to position the patient in lumbar kyphosis.

Having regard to prior known solutions, there is an apparent need for an accessory with which to maintain a patient in a position which firstly is optimal for performing a lumbar puncture, and secondly is comfortable so as to achieve muscle relaxation.

The purpose of the invention is therefore to meet this need by putting forward a device allowing a patient both to adopt an optimal lumbar kyphosis position and to achieve relaxation of the para-vertebral muscles.

A further purpose of the invention is to propose a device of simple design and easy to use whilst ensuring correct, safe positioning of the patient.

The subject-matter of the invention therefore concerns a device for positioning a patient, who is to undergo a lumbar puncture, that has a so-called sagittal plane of symmetry and a front leaning surface for the patient's abdomen and thorax bordered on either side by two side faces. According to the invention, the device consists of a rigid or semi-rigid cushion comprising:
a placing surface having an anterior edge and resting on the patient's thighs,
a front leaning surface rising above the placing surface from the anterior edge and having a convex profile in the sagittal plane of symmetry to position the patient's spine in kyphosis, this front leaning surface ending opposite the anterior edge in a housing for supporting and laterally centring the patient's head, centred along the plane of sagittal symmetry.
two side faces containing a clasping surface orientated in the opposite direction to the front leaning surface to enable at least part of the upper limbs to hold the cushion against the patient's abdomen and thorax.

According to one advantageous embodiment, the device comprises a cut-out at its anterior edge to receive the abdomen leaving abutments either side to wedge the cushion against the patient's pelvis.

According to one preferred characteristic of embodiment, the placing surface is provided with two channels to fit over at least part of the patient's thighs.

Further preferably, the channels extend opposite the anterior edge over a limited distance projecting from a planar surface which extends as far as the anterior edge.

The device of the invention is also adapted to prevent painful compression of the central venous pathways which may arise in some patients. Therefore the front leaning surface is provided with two hollowed areas centred either side of the plane of sagittal symmetry and extending crosswise as far as the side faces.

According to a preferred characteristic of embodiment, the clasping surface is formed by part of the inner surface of a transverse cavity opening into the two side faces.

Further preferably, the device comprises an access passage leading into the transverse cavity and starting at a posterior face of the cushion extending between the placing surface and the front leaning surface. Said passage gives access to the patient's hands and forearms to provide reassurance if necessary.

According to another preferred characteristic of embodiment, the housing opens opposite the front leaning surface into a clearing around the patient's face enabling the patient to freely talk and breathe. Said clearing can also be used for positioning a mask for optional supply of nitrous oxide for example to the patient during the procedure.

According to a preferred characteristic of embodiment the cushion is made in polyethylene foam for example.

Further preferably the cushion is provided with a protective cover so that it can be decontaminated.

Various other characteristics will become apparent from the description given below with reference to the appended drawings, which as non-limitative examples, illustrate embodiments of the subject of the invention.

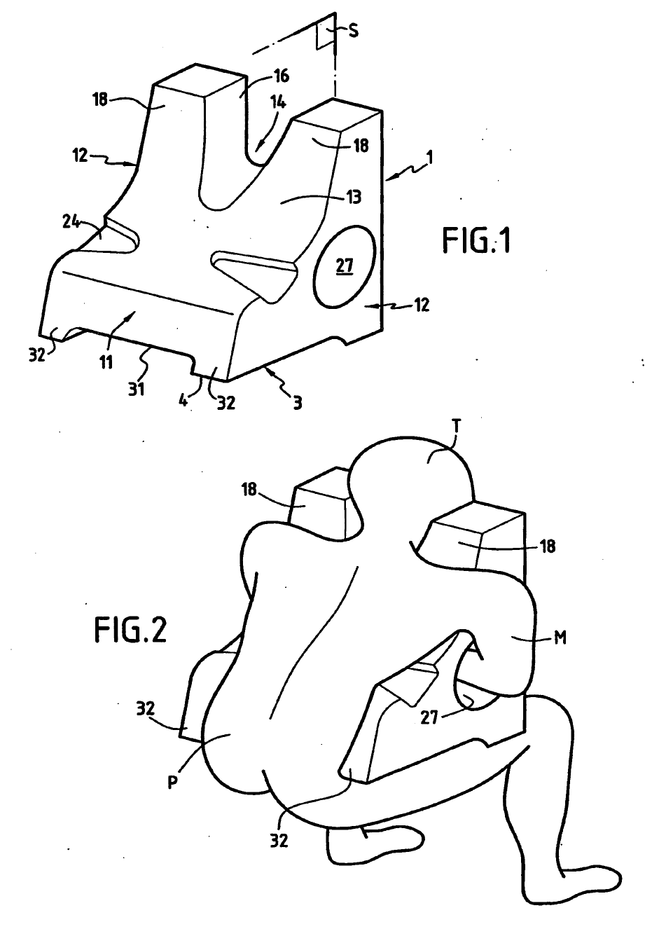

FIG. 1 is a perspective view showing an example of embodiment of a positioning device according to the invention.

FIG. 2 is a perspective view showing an example of use of the inventive positioning device by a patient.

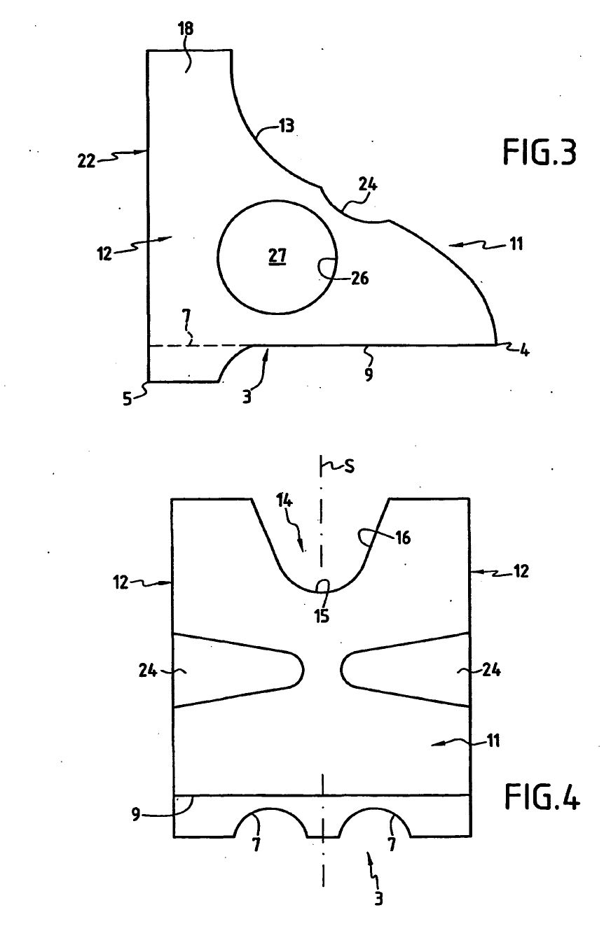

FIG. 3 is an elevation view of the positioning device illustrated FIG. 1.

FIG. 4 is a front elevation view of the positioning device of the invention.

FIG. 5 is an overhead view of the positioning device of the invention.

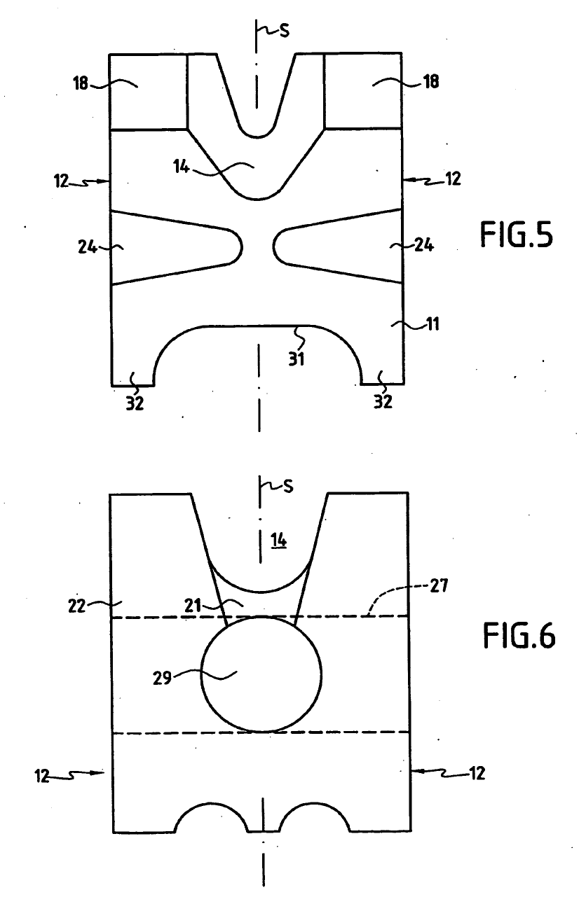

FIG. 6 is a posterior view of the positioning device of the invention.

As can be seen in the figures, the subject of the invention is a device made in the form of a rigid or semi-rigid cushion 1 for the correct positioning of a patient P, who is preferably to undergo a lumbar puncture. The cushion 1 has a so-called sagittal plane of symmetry S with respect to the anatomical plane.

As can be seen more precisely FIGS. 3 and 4, cushion 1 comprises a placing surface 3 which rests on the patient's thighs, extending between an anterior edge 4 and a posterior edge 5. According to a preferred characteristic of embodiment, the placing surface 3 is provided with two channels 7 to receive at least part of the patient's thighs. The channels 7 are cut symmetrically either side of the plane of sagittal symmetry S so that when positioned on the thighs the cushion 1 lies centred along the patient's sagittal plane. Preferably, each channel 7 has a substantially semi-circular section to allow at least partial insertion of the upper part of the thighs. The channels 7 preferably extend over a limited length from the posterior edge 5 so that they can be fitted over the anterior parts of the thighs irrespective of their size. The channels 7 therefore project from a planar surface 9 extending as far as the anterior edge 4. It is to be understood that this planar surface 9 is intended just to bear upon the upper surface of the patient's thighs who, as illustrated FIG. 2, is in seated position.

The cushion 1 also comprises a front leaning surface 11 for at least part of the patient's abdomen and thorax. This front leaning surface 11 is continued either side, substantially at right angles, by two side faces 12 extending parallel to one another and to the sagittal plane of symmetry S as far as the placing surface 3. The front leaning surface 11 rises above the placing surface 3 from the anterior edge 4 so that the planes of general orientation between the front leaning surface 11 and the placing surface 3 together define an acute angle. Therefore as can be clearly seen FIG. 3 the front leaning surface 11 and the placing surface 3 together form a general wedge shape starting at the anterior edge 4.

According to one characteristic of the invention the front leaning surface 11, in the plane of sagittal symmetry S, has a convex profile to position the patient's spine correctly in kyphosis when the patient's abdomen and thorax bear upon this front leaning surface 11. Starting at the anterior edge 4 and in the direction of its opposite so-called upper edge 13, the front leaning surface 11 has a convex profile.

The front leaning surface 11 ends opposite the anterior edge 4, i.e. at its upper edge 13, in a housing 14 for supporting and laterally centring the patient's head H. This housing 14 which opens in the upper part of the front leaning surface 11 is centred on the plane of sagittal symmetry S making it possible to position the head correctly in the continuation of the patient's spine.

As can be seen more precisely FIGS. 1 and 4, the housing 14 has a bottom part 15 of substantially circular section extended by sides 16 acting as temporal rests for the head and preferably slightly divergent from one another. Said housing 14 provides stable, trauma-free support for the patient's head insofar as the head fits naturally into the housing via a downward movement. It is to be noted that either side of housing 14 there subsist solid parts 18 extending the front leaning surface 11 beyond its upper edge 13 and projecting upwards from this front surface. These projecting solid parts 18 form a support for the patient's shoulders when the patient is in contact with the front leaning surface 11 as illustrated FIG. 2.

According to a preferred characteristic of embodiment, the housing 14 opposite the front leaning surface 11 opens into a clearing 21 arranged in the rear side 22 of cushion 1 which extends in a plane substantially perpendicular to the surface of the placing plane 9, between this placing surface 3 and the front leaning surface 11 (FIG. 6). The clearing 21 enables the patient to talk and breathe freely. Said clearing 21 also makes it possible to position a mask on the patient's face, to deliver nitrous oxide for example.

According to another preferred characteristic of embodiment, the front leaning surface 11 is provided with two hollowed parts 24 centred either side of the plane of sagittal symmetry S and extending substantially crosswise as far as the side faces 12. Each hollowed part 24 which is initially recessed for example with respect to the plane of sagittal symmetry S has a divergent shape as far as the side faces 12. Said hollowed parts 24 prevent painful compression of the patient's central venous pathways.

According to a preferred characteristic of embodiment, the cushion 1 has a clasping surface 26 orientated in opposite direction to the front leaning surface 11 to allow at least part of the upper limbs L de hold cushion 1 tight against the patient's abdomen and thorax. In the illustrated example, the clasping surface 26 is partly formed of the inner surface of a transverse cavity 27 opening into the two side faces 12 and arranged in a direction substantially perpendicular to the plane of sagittal symmetry S. The hands, forearms and even the arms can be inserted inside said cavity 27 to grasp hold of the cushion 1 whilst relaxing the para-vertebral muscles.

According to a preferred characteristic of embodiment, the cushion 1 comprises an access passage 29 opening into the transverse cavity 27 and starting at the posterior surface 22 of the cushion (FIG. 6). Said passage 29 can be used for example to access the patient's hands from the posterior surface 22 in order to reassure the patient.

According to a further preferred characteristic of embodiment, the cushion 1 comprises a cut-out 31 at the anterior edge 4 to allow passing of the abdomen leaving abutments 32 to subsist either side of the cushion 1 to cushion the patient's pelvis. As shown more precisely FIGS. 2 and 5 the front leaning surface 11 therefore has a cut-out at its anterior edge 4 leaving a U-shaped profile to subsist at this anterior edge allowing the cushion to be positioned correctly with respect to the patient's body.

As arises directly from the above description, cushion 1 of the invention has an anatomic shape enabling the patient to adopt a position of optimal lumbar kyphosis for performing a lumbar puncture while being in a state of muscle relaxation on account of the stable posture obtained. The inventive cushion 1 provides proper cushioning of the patient's torso and pelvis while positioning the spine in a plane.

Preferably the inventive cushion 1 is made in a rigid or semi-rigid material. For example the cushion 1 is made in low or medium density polyethylene foam. Preferably the cushion is provided with a protective cover to allow easy decontamination.

Evidently the cushion 1 may be made in several sizes, four for example to cover the adaptive needs of patients aged from two years up to adult age.

The invention is not limited to the described and illustrated examples since they may undergo various modifications without departing from the scope of the invention. In this respect, it is to be noted for example that the clasping surface 26 could be arranged directly on the posterior surface 22 of the cushion. Similarly the side faces 12 of the cushion could be hollowed or cut out to save on material. Also, the preceding description relates to the use of a cushion to facilitate lumbar punctures. It is evident that the inventive cushion may be given other applications such as epidural injections for example for women giving childbirth. In this example of application the anatomic shape of the front leaning surface 11 has to be modified. For example the front leaning surface 11 could be provided with a scooped-out part starting at the anterior edge 4.

1. Device for positioning a patient (P) having to undergo a lumbar puncture in particular, which has a plane of sagittal symmetry (S) and comprises a front leaning surface (11) for the patient's abdomen and thorax, bordered on either side by side faces (12) characterized in that it is made in the form of a rigid or semi-rigid cushion (1) comprising:
a placing surface (3), provided with an anterior edge (4), resting on the patient's thighs,
a front leaning surface (11) rising above the placing surface (3) from the anterior edge (4) and which, in the plane of sagittal symmetry (S), has a convex profile to position the patient's spine in kyphosis, this front leaning surface (11) opposite the anterior edge leading into a housing (14) for the support and lateral centring of the patient's head centred along the plane of sagittal symmetry,
and two side faces (12) into which a clasping surface (26) opens orientated in opposite direction to the front leaning surface (11), to allow at least part of the upper limbs to clasp the cushion against the patient's abdomen and thorax.

2. Device as in claim 1 characterized in that, at the anterior edge (4), it comprises a cut-out passage (31) for the abdomen leaving abutments (32) subsisting on either side to wedge the cushion against the patient's pelvis.

3. Device as in claim 1, characterized in that the placing surface (3) is provided with two channels (7) to receive at least part of the patient's thighs.

4. Device as in claim 3, characterized in that the channels (7) extend opposite the anterior edge (4) over a limited distance and projecting from a planar surface (9) which extends as far as the anterior edge (4).

5. Device as in claim 1, characterized in that the front leaning surface (11) is provided with two hollowed parts (24) centred either side of the plane of sagittal symmetry (S) extending crosswise as far as the side faces (12).

6. Device as in claim 1, characterized in that the clasping surface (26) is formed partly by the inner surface of the transverse cavity (27) leading into the two side faces (12).

7. Device as in claim 6, characterized in that it comprises an access passage (29) opening into the transverse cavity (27) and starting at the posterior face (22) of the cushion extending between the placing surface (3) and the front leaning surface (11).

8. Device as in claim 1, characterized in that the housing (14) opens opposite the front leaning face (11) in a clearing (21).

9. Device as in claim 1, characterized in that the cushion (1) is made in polyethylene foam for example.

10. Device as in claim 1, characterized in that the cushion (1) is provided with a protective cover allowing its decontamination.
